(19) United States
(12) Patent Application Publication
(10) Pub. No.: US 2021/0125613 A1
(43) Pub. Date: Apr. 29, 2021

(54) A RELAY DEVICE

(71) Applicant: Schneider Electric Asia Pte Ltd, Singapore (SG)

(72) Inventor: Boon Meng GOH, Singapore (SG)

(21) Appl. No.: 17/051,934

(22) PCT Filed: Mar. 1, 2019
(86) PCT No.: PCT/SG2019/050117

§ 371 Date: Oct. 30, 2020

(30) Foreign Application Priority Data
May 18, 2018 (SG) 10201804226Y

(51) Int. Cl. G10L 15/22; H01H 47/02

(52) U.S. Cl. CPC G10L 15/22; H01H 47/02

(57) ABSTRACT

A relay device, a method of forming a relay device and a method of controlling a relay device are provided, the relay device comprising an audio input member disposed on a first surface of the relay device; a first storage member; an instructions database stored in the first storage member, the instructions database configured to store one or more instructions, each instruction corresponding to a command; and a processing module coupled to the audio input member and arranged to receive an audio signal from the audio input member; wherein the processing module is further arranged to identify a command from the audio signal and to retrieve one or more instructions from the instructions database corresponding to the command, and the processing module is further arranged to perform the retrieved one or more instructions.

### TECHNICAL FIELD

The present disclosure relates broadly to a relay device, to a method for forming a relay device, and to a method for controlling a relay device.

### BACKGROUND

Conventionally, relay devices include dials or dial buttons for adjusting relay settings. With such relay devices, in order to manipulate the dial buttons, one may require a suitable tool such as a flat-head screw driver or even a human finger to adjust relay settings. However, it has been recognised that, in some scenarios, such as in tight spaces, using a tool to manipulate dials may not be convenient to a user. Furthermore, due to the sizes of conventional relay devices, adjustment of the dials using a tool may not be accurate. In addition, in a scenario of having multiple relay devices arranged in a same location and each relay device having a plurality of dials, it may be a problem for a user to adjust a certain setting of a particular relay device.

Further, for conventional relay devices, light-emitting diode (LED) indicators are typically provided on the relay devices for alerting users of faults or communicating other information such as settings or readings to the users. Such LED indicators may typically communicate e.g. the type of fault detected based on the number of times the LED indicators blink or turn on/off. However, it has been recognised that a user may wrongly count the number of times a LED indicator blinks, and consequently, may interpret the type of fault detected incorrectly.

There have been provided relay devices with liquid-crystal displays (LCDs) to display information e.g. faults detected. However, it has been recognised by the inventors that using LCDs is costly. Furthermore, provision of a LCD presents a constraint on the size of the final relay device. That is, it may be a problem to miniaturize a relay product if a LCD has to be provided and be visually usable to a user.

Furthermore, for settings and/or for interpreting faults, a user typically needs to use an instruction/specification list or sheet in conjunction with each relay device. That is, for example, for a LED indicator, the user may need to interpret the blinking pattern with a known pattern listed in the instruction/specification list or sheet. It has been recognised that if a user is not in possession of the instruction/specification list or sheet, the user may face a problem of not knowing how to perform a setting of a relay device or how to interpret a fault with a relay device.

In view of the above, there exists a need for a relay device, a method for forming a relay device and a method for controlling a relay device that seek to address at least one of the above problems.

### SUMMARY

In accordance with a first aspect of the present disclosure, there is provided a relay device, the relay device comprising, an audio input member disposed on a first surface of the relay device; a first storage member; an instructions database stored in the first storage member, the instructions database configured to store one or more instructions, each instruction corresponding to a command; and a processing module coupled to the audio input member and arranged to receive an audio signal from the audio input member; wherein the processing module is further arranged to identify a command from the audio signal and to retrieve one or more instructions from the instructions database corresponding to the command, and the processing module is further arranged to perform the retrieved one or more instructions.

The processing module may be arranged to enter a communication mode upon receiving a unique ID of the relay device as the command.

The relay device may further comprise at least one output member disposed on the first surface or a second surface of the relay device and coupled to the processing module.

The at least one output member may be an audio output member.

The audio output member may be a speaker.

The at least one output member may be a visual output member.

The visual output member may be a light-emitting diode (LED).

The relay device may further comprise an audio database configured to store audio profiles of one or more users, the audio database being stored on the first storage member.

The relay device may further comprise an actuator coupled to the processing module of the relay device, the actuator configured to cause the processing module to begin identification of the command from the audio signal.

In accordance with a second aspect of the present disclosure, there is provided a method of forming a relay device, the method comprising, disposing an audio input member on a first surface of the relay device; providing a first storage member; storing an instructions database in the first storage member; storing one or more instructions on the instructions database, each instruction corresponding to a command; coupling a processing module to the audio input member to receive an audio signal from the audio input member; providing the processing module to identify a command from the audio signal and to retrieve one or more instructions from the instructions database corresponding to the command; and providing the processing module to perform the retrieved one or more instructions.

The method may further comprise providing the processing module to enter a communication mode upon receiving a unique ID of the relay device as the command.

The method may further comprise disposing at least one output member on the first surface or a second surface of the relay device and coupling the at least one output member to the processing module.

The method may further comprise storing audio profiles of one or more users on an audio database, the audio database being stored on the first storage member.

The method may further comprise coupling an actuator to the processing module of the relay device to cause the processing module to begin identification of the command from the audio signal.

In accordance with a third aspect of the present disclosure, there is provided a method of controlling a relay device, the method comprising, receiving an audio signal from an audio input member disposed on a first surface of the relay device; identifying a command from the audio signal; retrieving one or more instructions from an instructions database corresponding to the command, the instructions database being stored in a first storage member of the relay device, the instructions database having stored thereon one or more instructions, each instruction corresponding to a command; and performing the retrieved one or more instructions.

The method may further comprise entering a communication mode upon receiving a unique ID of the relay device as the command.

The method may further comprise providing at least one output from the relay device via an output member.

The at least one output may be an audio output.

The at least one output may be a visual output.

The method may further comprise using an audio database having stored thereon audio profiles of one or more users, the audio database being stored on the first storage member.

The method may further comprise actuating an actuator of the relay device to begin the step of identifying a command from the audio signal.

In accordance with a fourth aspect of the present disclosure, there is provided a non-transitory computer readable storage medium having stored thereon instructions for instructing a processing module of a relay device to execute a method of controlling a relay device, the method comprising, receiving an audio signal from an audio input member disposed on a first surface of the relay device; identifying a command from the audio signal; retrieving one or more instructions from an instructions database corresponding to the command, the instructions database being stored in a first storage member of the relay device, the instructions database having stored thereon one or more instructions, each instruction corresponding to a command; and performing the retrieved one or more instructions.

### BRIEF DESCRIPTION OF THE DRAWINGS

Exemplary embodiments of the present disclosure will be better understood and readily apparent to one of ordinary skill in the art from the following written description, by way of example only, and in conjunction with the drawings, in which:

FIG. 1 is a schematic diagram illustrating a relay device in an exemplary embodiment.

FIG. 2A is a schematic drawing illustrating an isometric view of a relay device in an exemplary embodiment.

FIG. 2B is a schematic drawing illustrating a front view of the relay device of FIG. 2A.

FIG. 3 is a schematic flowchart for illustrating a process for controlling a relay device in an exemplary embodiment.

FIG. 4 is a schematic flowchart for illustrating a process for changing one or more settings of a relay device in an exemplary embodiment.

FIG. 5 is a schematic flowchart for illustrating a process for requesting information on a latest setting of a relay device in an exemplary embodiment.

FIG. 6 is a schematic flowchart for illustrating a process for requesting information on one or more fault conditions related to a relay device in an exemplary embodiment.

FIG. 7 is a schematic flowchart for illustrating a process for initialising voice recognition for a relay device in an exemplary embodiment.

FIG. 8 is a schematic flowchart for illustrating a process for assigning a unique ID to a relay device in an exemplary embodiment.

FIG. 9 is a schematic diagram illustrating a system for configuring a relay device in an exemplary embodiment.

FIG. 10 is a schematic drawing of a computer system suitable for storing instructions in a relay device in exemplary embodiment.

FIG. 11 is a schematic flowchart for illustrating a method of forming a relay device in an exemplary embodiment.

FIG. 12 is a schematic flowchart for illustrating a method of controlling a relay device in an exemplary embodiment.

### DETAILED DESCRIPTION

Exemplary embodiments described below may provide a relay device and a method of controlling a relay device.

In an exemplary embodiment, a relay device is provided comprising an audio input member disposed on a first surface of the relay device, a first storage member, an instructions database stored in the first storage member, the instructions database configured to store one or more instructions, each instruction corresponding to a command, a processing module coupled to the audio input member and arranged to receive an audio signal from the audio input member wherein the processing module is further arranged to identify a command from an audio signal and to retrieve one or more instructions from the instructions database corresponding to the command, and the processing module is further arranged to perform the retrieved one or more instructions.

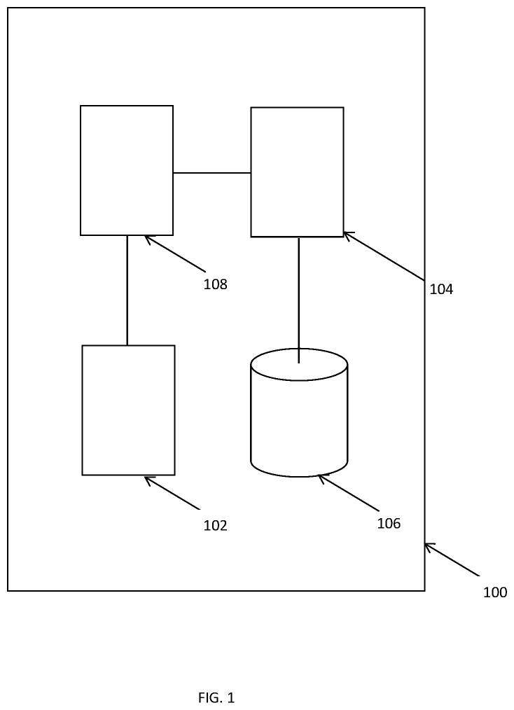

FIG. 1 is a schematic diagram illustrating a relay device 100 in an exemplary embodiment. The relay device 100 comprises an audio input member 102 and a first storage member 104. The relay device 100 further comprises an instructions database 106 and a processing module 108 coupled to the audio input member 102. The first storage member 104 is coupled to the processing module 108 and the instructions database 106 is stored in the first storage member 104.

In the exemplary embodiment, the audio input member 102 is disposed on a first surface of the relay device 100. The first surface may be a first external surface of the relay device 100. In other exemplary embodiments, the audio input member 102 may be disposed on an internal surface of the relay device 100. The audio input member 102 is configured to receive one or more audio signals such as, but is not limited to, a human voice. In the exemplary embodiment, the audio input member 102 is in the form of, but is not limited to, a microphone.

In the exemplary embodiment, the first storage member 104 is in the form of, but is not limited to, a Read Only Memory (ROM).

In the exemplary embodiment, the instructions database 106 is configured to store one or more instructions and each instruction corresponds to a command. The one or more instructions may be associated with a unique identification (ID) of the relay device 100, one or more settings of the relay device 100, one or more readings of the relay device 100 or one or more fault conditions related to the relay device 100. The command may be in any form where information is transmitted to the relay device. The information may be an audio command by a user.

In the exemplary embodiment, the processing module 108 is arranged to receive an audio signal from the audio input member 102. The processing module 108 is further arranged to identify a command from the audio signal and to retrieve one or more instructions from the instructions database 106 corresponding to the command, and the processing module 108 is configured to perform the retrieved one or more instructions.

In alternative exemplary embodiments, an audio database configured to store audio profiles of one or more users, the audio database being stored on the first storage member, may also be provided. In alternative exemplary embodiments, at least one output member, e.g. an audio output member and/or a visual output member, may also be provided. The at least one output member may be disposed on a same or a different surface as the audio input member.

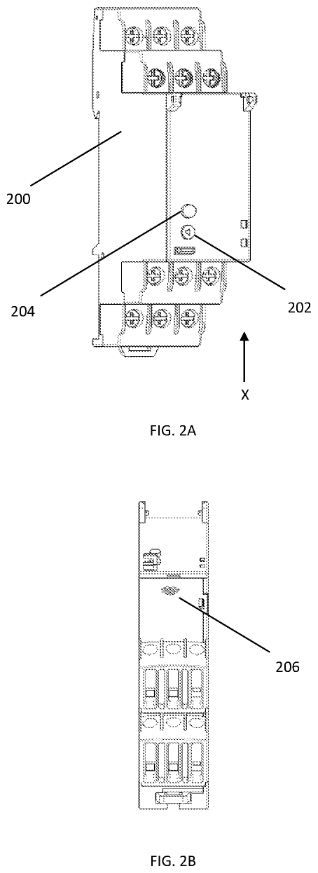

FIG. 2A is a schematic isometric view of a relay device 200 in an exemplary embodiment. The relay device 200 functions substantially similarly to the relay device 100 described with reference to FIG. 1.

In the exemplary embodiment, the relay device 200 comprises an audio input member in the form of a microphone 202. In the exemplary embodiment, the microphone 202 is disposed on a first surface of the relay device 200. The first surface is a top external surface of the relay device 200. The microphone 202 is configured to receive one or more audio signals in the form of, but not limited to, a human voice.

In the exemplary embodiment, the relay device 200 further comprises an indication LED 204. In the exemplary embodiment, the indication LED 204 is disposed on the first surface of the relay device 200. The indication LED 204 may also be positioned on any suitable position on the relay device 200. In the exemplary embodiment, the indication LED 204 is configured to output one or more signals. The one or more signals may be in the form of a visual signal to a user. The indication LED 204 may be referred to as an output member, e.g. a visual output member.

FIG. 2B is a schematic front view of the relay device of FIG. 2A, when viewed from direction X of FIG. 2A.

In the exemplary embodiment, the relay device 200 further comprises another output member e.g. an audio output member in the form of a speaker 206. In the exemplary embodiment, the speaker 206 is disposed on a second surface of the relay device 200. The second surface is a bottom external surface of the relay device 200. The speaker 206 may also be positioned on any suitable position on the relay device 200. In the exemplary embodiment, the speaker 206 is configured to output one or more signals. The one or more signals may be in the form of audio signals. Further, in the exemplary embodiment, the audio signal outputted mimics or is in a human language.

In the exemplary embodiment, the relay device 200 further comprises a first storage member (not shown). The first storage member stores an instructions database (not shown) that is configured to store one or more instructions, wherein each instruction corresponds to a command. The one or more instructions may be associated with a unique ID of the relay device 200, one or more settings of the relay device 200, one or more readings of the relay device 200 or one or more fault conditions related to the relay device 200.

In the exemplary embodiment, the first storage member additionally stores an audio database (not shown). The audio database is configured to store one or more audio profiles of one or more users.

In the exemplary embodiment, the relay device 200 comprises a processing module (not shown). In the exemplary embodiment, the processing module is coupled to the microphone 202 and the processing module is configured to obtain an audio signal via the microphone 202. The processing module is configured to identify an audio command from the audio signal obtained. Based on the audio command identified, the processing module is configured to retrieve one or more instructions from the instructions database corresponding to the audio command and to perform the retrieved one or more instructions.

In the exemplary embodiment, the relay device 200 may be controlled using voice recognition. The relay device 200 may be controlled to change the one or more settings of the relay device 200, to confirm the one or more settings of the relay device 200 that have been changed, or to output one or more fault conditions related to the relay device 200.

In the exemplary embodiment, before the relay device 200 is first used, the relay device 200 is initialised. In the exemplary embodiment, the relay device 200 is initialised based on an audio command by the user to assign a unique ID to the relay device 200. When the relay device 200 is first powered up, the processing module of the relay device 200 triggers the speaker 206 to output a first signal. In the exemplary embodiment, the first signal is a first audio signal inviting the initialisation by the user. For example, the audio signal output contains the words “initialise ID please”.

In the exemplary embodiment, after the first audio signal is outputted via the speaker 206, the user gives the relay device 200 an audio command associated with assigning/setting an unique ID via the microphone 202. For example, the user gives an audio command “ID123” where “123”, (or more broadly, “xxx”), is a unique ID to be assigned to the relay device 200. When the processing module of the relay device 200 determines that the audio command associated with the unique ID (“ID123”) has been received, the processing module recognises the unique ID and stores as the unique ID of the relay device.

In the exemplary embodiment, assigning a unique ID to each relay device avoids a situation where two or more relay devices respond to an audio command by the user at the same time. By assigning a unique ID to each relay device, when the user gives an audio command associated with a unique ID, the relay device assigned with the unique ID responds to the audio command. For example, the microphone 202 polls for an audio command with the unique ID and the relay device responds to a valid audio command comprising the unique ID by the processing module instructing to poll for a next audio command using the microphone 202. That is, the processing module instructs the relay device 200 to enter a “communication mode”. The “communication mode” refers to the processing module being ready to process subsequent commands received by the microphone 202 after the unique ID in the user's audio command is matched to the current relay device's unique ID.

In the exemplary embodiment, after the unique ID is stored in the relay device 200, the processing module triggers the speaker 206 to output a second signal. The second signal outputted by the speaker 206 is a second audio signal comprising the words “initialisation completed with ID123” to indicate that the initialisation of the relay device 200 is completed. In the exemplary embodiment, the processing module may also trigger the indication LED 204 to output a third signal. The third signal outputted by indication LED 204 is a visual signal. An example of the visual signal is the indication LED 204 blinking once. The third signal outputted by the indication LED 204 may also indicate to the user that the initialisation of the relay device 200 is completed.

In the exemplary embodiment, after initialising the relay device 200, the relay device 200 may be controlled based on voice recognition to change the one or more settings of the relay device 200. For example, the relay device 200 may be controlled by the user to change the under-voltage limit of the relay device 200.

In an example, to change the under-voltage limit of the relay device 200, the user provides a first command to the relay device 200 via the microphone 202. For example, the first command is associated with a unique ID of a relay device 200. In the exemplary embodiment, the first command is an audio command “ID123”. After the processing module of the relay device 200 receives the first command via the microphone 202 and determines that the user is communicating with the current relay device 200, the processing module polls for a next audio command. The processing module also triggers the indication LED 204 to either turn on or begin blinking to indicate to the user that the processing module is polling for a next audio command and that the relay device 200 has entered the “communication mode”. After the user provides a second command via the microphone 202, wherein the second command is an audio command associated with a desired under-voltage threshold setting of the relay device 200, the processing module changes/adjusts one or more settings of the relay device, for example to switch the state of the relay device 200 if the desired threshold is reached. In the exemplary embodiment, the relay device 200 exits the “communication mode” e.g. when the user provides a stop command to the relay device 200 via the microphone 202 or when the processing module determines that a pre-determined amount of time has passed i.e. time-out. For example, the stop command is an audio command “stop activity”. When the relay device 200 exits the “communication mode”, the processing module triggers the indication LED 204 to blink in a pre-determined manner to indicate to the user that the relay device 200 has exited the “communication mode”. In this step, if the indication LED 204 has already been blinking (for other reasons) prior to this step, the indication LED 204 may blink differently from the manner in which the indication LED 204 has been blinking (for example, the indication LED 204 may blink in a faster sequence).

In another example, the relay device 200 can be controlled to also confirm the one or more settings of the relay device 200. This can be performed in a manner similar to how the relay device 200 can be controlled by the user to change the under-voltage limit (described above), except that the second command is associated with confirming or requesting the one or more settings of the relay device 200 (instead of being associated with the desired under-voltage limit). For example, the second command is an audio command “confirm setting” or “current setting” provided by the user via the microphone 202. The processing module, in the “communication mode”, receives the second command and retrieves the one or more corresponding instructions associated with the command. For example, the instructions may be to retrieve the current settings from a database. The processing module outputs an audio signal via the speaker 206 with information on the one or more settings of the relay device 200 e.g. that has been recently changed.

In another example, the relay device 200 can be controlled to output a current state or one or more fault conditions related to the relay device 200. This can be performed in a manner similar to how the relay device 200 can be controlled by the user to change the under-voltage limit, except that the second command is associated with obtaining information on the current state or the one or more fault conditions related to the relay device 200 (instead of being associated with the desired under-voltage limit). For example, the second command is an audio command “fault information” or “current state” provided by the user via the microphone 202. The processing module, in the “communication mode”, receives the second command and retrieves the one or more corresponding instructions associated with the command. For example, the instructions may be to retrieve the current state or registered fault condition from a database. The processing module outputs an audio signal via the speaker 206 with information on the current state or one or more fault conditions related to the relay device 200.

For scenarios such as requesting current setting or requesting current state or one or more fault conditions, that is, if it is a request for information from the relay device 200, the relay device 200 may be configured to exit the “communication mode” after providing the information.

In the above examples, if an audio stop command e.g. “stop activity” is received, the relay device 200 may be configured to wait for a delay time-period of e.g. 5 seconds for another audio command. If no audio command to the relay device 200 is received during the delay time-period, the relay device 200 is configured to exit the “communication mode”. If an audio command is received during the delay time-period, the relay device 200 continues to process the received audio command.

In the exemplary embodiment, at the stage of the relay device 200 commencing to exit the “communication mode” e.g. after the user provides a stop command to the relay device 200, there is provided a delay time-period of e.g. 5 seconds before the relay device 200 exits the “communication mode”.

For the relay device 200 to enter the “communication mode” again, the user is to provide the first command to the relay device 200 via the microphone 202 again.

The above-described ways of controlling the relay device 200 are further described below.

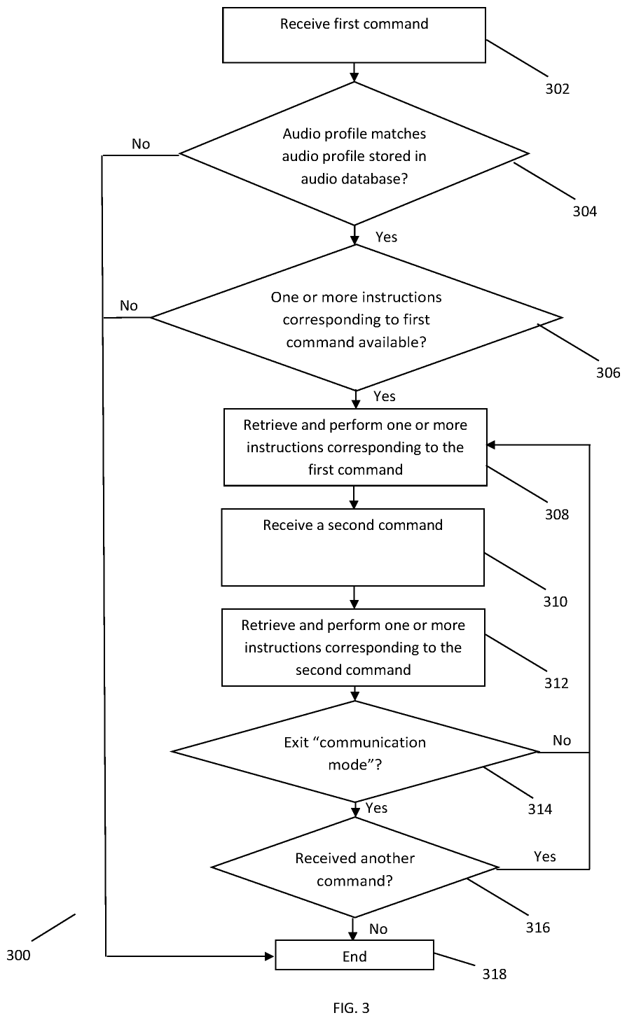

FIG. 3 is a schematic flowchart 300 for illustrating a process for controlling a relay device in an exemplary embodiment. The relay device is substantially similar to the relay device 100 described with reference to FIG. 1. In the exemplary embodiment, controlling the relay device refers to performing an activity using the relay device.

At step 302, a processing module of the relay device receives a first command by the user via an audio input member of the relay device. In the exemplary embodiment, the first command is an audio signal such as a human voice. In the exemplary embodiment, the first command is associated with a unique ID assigned to the relay device.

At step 304, the processing module generates an audio profile based on the first command obtained at step 302 and determines whether the audio profile matches an audio profile stored in the audio database of the relay device. If there is no match, the process ends. If there is a match, the process proceeds to step 306.

At step 306, the processing module determines if there are one or more instructions stored in the instructions database of the relay device that correspond to the first command obtained at step 302. If there are no instructions that correspond to the first command, the process ends. If there are one or more instructions that correspond to the first command, the process proceeds to step 308. For example, the processing module checks if the relay device is being referred to by the user by its unique ID.

At step 308, the processing module retrieves the one or more instructions stored in the instructions database that correspond to the first command obtained at step 302 and performs the one or more instructions. For example, the one or more instructions are for the processing module to poll for a next or second audio command. That is, the relay device has entered a “communication mode”.

At step 310, the processing module receives a second command by the user via the audio input member. The second command may be information transmitted by the user to the relay device. In the exemplary embodiment, the second command is an audio signal such as a human voice. The second command may be associated with, but is not limited to, one or more settings of the relay device, one or more readings of the relay device or one or more fault conditions related to the relay device.

At step 312, the processing module retrieves one or more instructions stored in the instructions database that correspond to the second command and performs the one or more instructions. The one or more instructions retrieved and performed may be changing/adjusting one or more settings of the relay device, outputting one or more readings of the relay device or outputting one or more current status or fault conditions of the relay device.

At step 314, the processing module determines whether the relay device is to begin exiting the “communication mode”. In the exemplary embodiment, if the processing module receives a stop command via the audio input member of the relay device, the relay device begins to exit the “communication mode”. For example, the stop command is an audio command “stop activity”. Further, in the exemplary embodiment, if the processing module detects that a pre-determined amount of time has passed after an audio command has been received/acted upon, the processing module may also begin to exit the “communication mode” (i.e. time-out). The pre-determined amount of time may be 3 seconds, 5 seconds or any other suitable amount of time. If the processing module determines that the relay device is to begin exiting the “communication mode”, the process proceeds to step 316.

At step 316, a delay time-period of e.g. 5 seconds is provided. If another audio command is provided by the user via the audio input member before the expiry of the delay time-period, the process loops to step 308. Otherwise, the process proceeds to step 318.

At step 318, the process ends and the relay device exits the “communication mode”.

In the exemplary embodiment, in order to further control the relay device, the process is repeated.

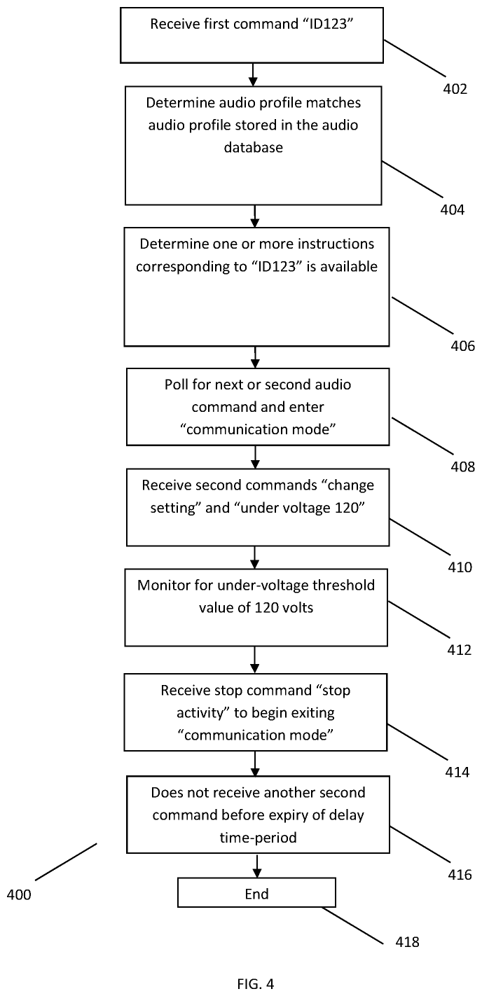

FIG. 4 is a schematic flowchart 400 for illustrating a process for changing one or more settings of a relay device in an exemplary embodiment. The relay device is substantially similar to the relay device 200 described with reference to FIGS. 2A and 2B. In the exemplary embodiment, the relay device is assigned a unique ID “ID123” to select the current relay device.

At step 402, the processing module of the relay device receives a first command by the user via a microphone. In the exemplary embodiment, the first command is an audio command “ID123” by the user.

At step 404, the processing module generates an audio profile based on the first command “ID123” obtained at step 402 and determines whether the audio profile matches an audio profile stored in the audio database of the relay device. In the exemplary embodiment, the processing module determines that there is a match and the process proceeds to step 406.

At step 406, the processing module determines if there are one or more instructions stored in the instructions database of the relay device that correspond to the first command “ID123”. In the exemplary embodiment, the processing module determines that there are one or more instructions corresponding to the first command “ID123” and the process proceeds to step 408. That is, the processing module determines that “ID123” is a valid unique ID for the current relay device.

At step 408, the relay device enters a “communication mode”. The processing module polls for a next or second audio command via the microphone. In the exemplary embodiment, the processing module further triggers an indication LED of the relay device to be turned on or to blink to indicate to the user that the processing module is polling for a next or second audio command and that the relay device is in the “communication mode”.

At step 410, the processing module receives a second command by the user via the microphone. In the exemplary embodiment, the second command is an audio command “change setting”. In the exemplary embodiment, the second command “change setting” instructs the processing module to poll for a next audio command that relates to a change in a setting of the relay device. That is, the processing module may retrieve an instruction corresponding to “change setting” and performs the waiting for a next command. The user transmits another command “under voltage 120”. “Under voltage 120” is an example of a piece of information transmitted by the user to the relay device via the microphone to instruct the relay device to switch the relay device if a measured voltage at the relay device is lower than 120 volts.

At step 412, the processing module retrieves and performs the one or more instructions stored in the instructions database that correspond to the command “under voltage 120”. In the exemplary embodiment, the processing module retrieves and performs an instruction for the processing module to monitor for an under-voltage threshold value of 120 volts based on identification of “under voltage” and a value “120” and to switch the relay device when a measured voltage at the relay device is below 120 volts. In the exemplary embodiment, the processing module further retrieves and performs an instruction to trigger the indication LED of the relay device to provide a visual indication e.g. to blink in a pre-determined sequence such as blink twice when the prior retrieved one or more instructions (of changing the settings) at step 412 have been performed successfully and to provide another visual indication e.g. to blink in another pre-determined sequence such as to blink once when the prior retrieved one or more instructions (of changing the settings) at step 412 are not performed successfully. In the exemplary embodiment, the manner in which the indication LED blinks at step 412 indicates to the user whether the prior retrieved one or more instructions at step 412 have been performed successfully. In the exemplary embodiment, if the indication LED blinked at step 408, the processing module is configured to trigger the indication LED to blink in a different manner at step 412. For example, at step 412, the indication LED blinks in a faster sequence than at step 408.

At step 414, the processing module receives a stop command (an audio command) “stop activity” by the user via the microphone and the relay device begins to exit the “communication mode”.

At step 416, a delay time-period of e.g. 5 seconds is provided. In the exemplary embodiment, the processing module does not receive another command before the expiry of the delay time-period and the process proceeds to step 418.

At step 418, the process ends. In the exemplary embodiment, the relay device exits the “communication mode”. Further, in the exemplary embodiment, at step 418, the processing module triggers the indication LED to blink (differently from that at step 408 and step 412) to indicate to the user that the processing module has exited the “communication mode”. For example, the indication LED blinks in a slower sequence than at both steps 408 and 412. The relay device therefore has a changed setting of “under voltage 120”.

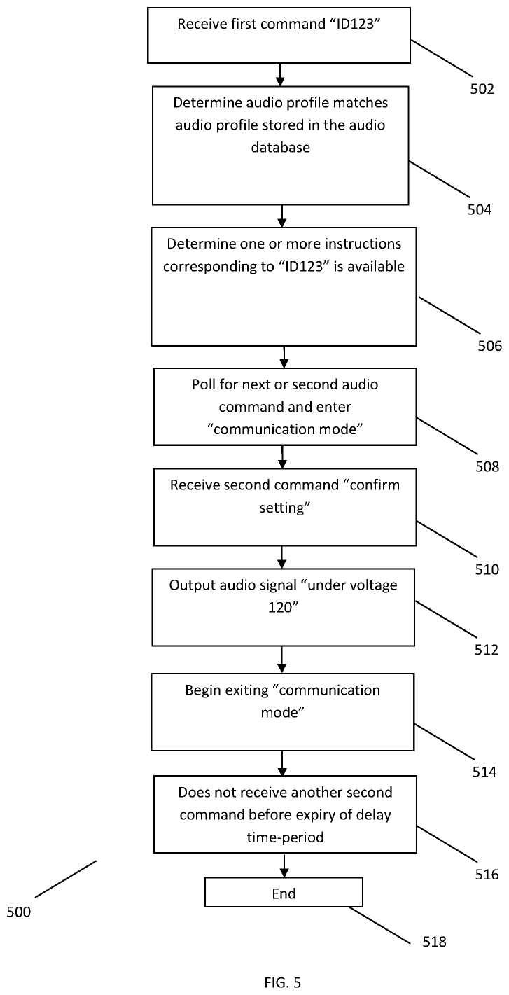

FIG. 5 is a schematic flowchart 500 for illustrating a process for requesting information on a latest setting of a relay device in an exemplary embodiment. The relay device is substantially similar to the relay device 200 described with reference to FIGS. 2A and 2B. In the exemplary embodiment, the relay device is assigned a unique ID “ID123” to select the current relay device.

At step 502, the processing module of the relay device receives a first command received by the user via a microphone. In the exemplary embodiment, the first command is an audio command “ID123” by a user.

At step 504, the processing module generates an audio profile based on the first command “ID123” obtained at step 502 and determines whether the audio profile matches an audio profile stored in the audio database of the relay device. In the exemplary embodiment, the processing module determines that there is a match and the process proceeds to step 506.

At step 506, the processing module determines if there are one or more instructions stored in the instructions database of the relay device that correspond to the first command “ID123”. In the exemplary embodiment, the processing module determines that there are one or more instructions that correspond to the first command “ID123” and the process proceeds to step 508. That is, the processing module determines that “ID123” is a valid unique ID for the current relay device.

At step 508, the relay device enters a “communication mode”. The processing module polls for a next or second audio command via the microphone. In the exemplary embodiment, the processing module further triggers an indication LED of the relay device to be turned on or to blink to indicate to the user that the processing module is polling for a next or second audio command and that the relay device is in the “communication mode”.

At step 510, the processing module receives a second command “confirm setting” by the user via the microphone. In the exemplary embodiment, the second command is an audio command “confirm setting”. In the exemplary embodiment, the second command “confirm setting” is an example of a command transmitted by the user to the relay device via the microphone to request for information on the latest setting of the relay device.

At step 512, the processing module retrieves and performs the one or more instructions stored in the instructions database that correspond to the second command “confirm setting”. For example, in a scenario in which the latest setting of the relay device is for the processing module to monitor for an under-voltage threshold value of 120 volts and to switch the relay device when a measured voltage at the relay device is below 120 volts, the relay device outputs the information of this latest setting of the relay device. In the exemplary embodiment, one way of outputting this information is to formulate an output in the form of an audio signal based on one or more pre-prepared phrases that are associated with the latest setting and that are stored in the first storage member, and to trigger a speaker of the relay device to output the audio signal. For example, the processing module triggers the speaker to output an audio signal with the phrase “under voltage 120”. In the exemplary embodiment, the processing module further retrieves and performs an instruction to trigger the indication LED of the relay device to provide a visual indication e.g. to blink in a pre-determined sequence such as blink twice when the prior retrieved one or more instructions (of a read-back of the settings) at step 512 have been performed successfully and to provide another visual indication e.g. to blink in another pre-determined sequence such as to blink once when the prior retrieved one or more instructions (of a read-back of the settings) at step 512 are not performed successfully. In the exemplary embodiment, the manner in which the indication LED blinks at step 512 indicates to the user whether the prior retrieved one or more instructions at step 512 have been performed successfully. In the exemplary embodiment, if the indication LED blinked at step 508, the processing module is configured to trigger the indication LED to blink in a different manner at step 512. For example, at step 512, the indication LED blinks in a faster sequence than at step 508.

At step 514, the relay device begins to exit the “communication mode”.

At step 516, a delay time-period of e.g. 5 seconds is provided. In the exemplary embodiment, the processing module does not receive another command before the expiry of the delay time-period and the process proceeds to step 518.

At step 518, the process ends. In the exemplary embodiment, the relay device exits the “communication mode”. Further, in the exemplary embodiment, at step 518, the processing module triggers the indication LED to blink (differently from that at step 508 and step 512) to indicate to the user that the processing module has exited the “communication mode”. For example, the indication LED blinks in a slower sequence than at both steps 508 and 512.

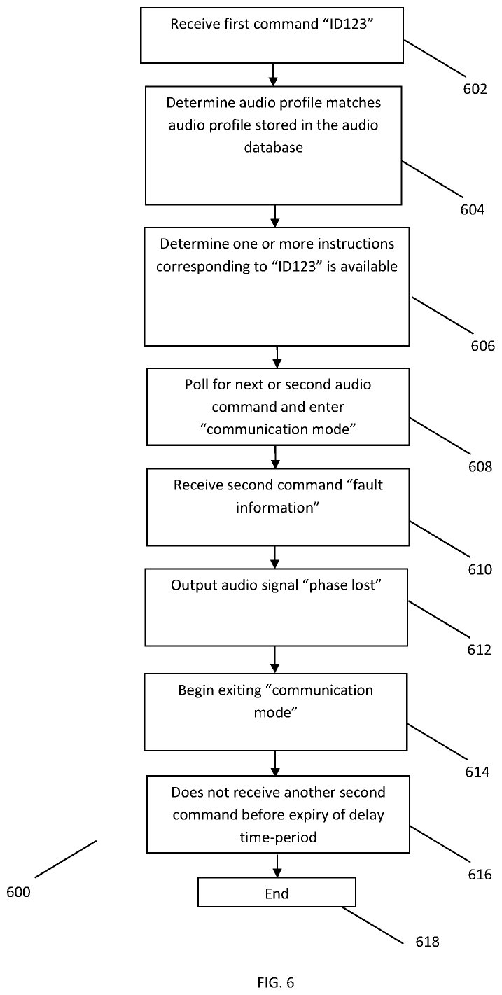

FIG. 6 is a schematic flowchart 600 for illustrating a process for requesting information on one or more fault conditions related to a relay device in an exemplary embodiment. The relay device is substantially similar to the relay device 200 described with reference to FIGS. 2A and 2B. In the exemplary embodiment, the relay device is assigned a unique ID “ID123” to select the current relay device.

At step 602, the processing module of the relay device receives a first command received by the user via a microphone. In the exemplary embodiment, the first command is an audio command “ID123” by a user.

At step 604, the processing module generates an audio profile based on the first command “ID123” obtained at step 602 and determines whether the audio profile matches an audio profile stored in the audio database of the relay device. In the exemplary embodiment, the processing module determines that there is a match and the process proceeds to step 606.

At step 606, the processing module determines if there are one or more instructions stored in the instructions database of the relay device that correspond to the first command “ID123”. In the exemplary embodiment, the processing module determines that there are one or more instructions that correspond to the first command “ID123” and the process proceeds to step 608. That is, the processing module determines that “ID123” is a valid unique ID for the current relay device.

At step 608, the relay device enters a “communication mode”. The processing module polls for a next or second audio command via the microphone. In the exemplary embodiment, the processing module further triggers an indication LED of the relay device to be turned on or to blink to indicate to the user that the processing module is polling for a next or second audio command and that the relay device is in the “communication mode”.

At step 610, the processing module receives a second command “fault information” by the user via the microphone. In the exemplary embodiment, the second command is an audio command “fault information”. In the exemplary embodiment, the second command “fault information” is an example of a command transmitted by the user to the relay device via the microphone to request for information on one or more fault conditions related to the relay device.

At step 612, the processing module retrieves and performs the one or more instructions stored in the instructions database that correspond to the second command “fault information”. For example, in a scenario in which a state of the relay device was switched as a result of detecting e.g. a phase loss, the relay device outputs information on this fault condition of the relay device. In the exemplary embodiment, one way of outputting the information is to formulate an output in the form of an audio signal based on one or more pre-prepared phrases that are associated with the fault condition and that are stored in the first storage member, and to trigger a speaker of the relay device to output the audio signal. For example, the processing module triggers the speaker to output an audio signal with the phrase “phase lost”. In the exemplary embodiment, the processing module further retrieves and performs an instruction to trigger the indication LED of the relay device to provide a visual indication e.g. to blink in a pre-determined sequence such as blink twice when the prior retrieved one or more instructions (of a read-back of the current status) at step 612 have been performed successfully and to provide another visual indication e.g. to blink in another pre-determined sequence such as to blink once when the prior retrieved one or more instructions (of a read-back of the current status) at step 612 are not performed successfully. In the exemplary embodiment, the manner in which the indication LED blinks at step 612 indicates to the user whether the prior retrieved one or more instructions at step 612 have been performed successfully. In the exemplary embodiment, if the indication LED blinked at step 608, the processing module is configured to trigger the indication LED to blink in a different manner at step 612. For example, at step 612, the indication LED blinks in a faster sequence than at step 608.

At step 614, the relay device begins to exit the “communication mode”.

At step 616, a delay time-period of e.g. 5 seconds is provided. In the exemplary embodiment, the processing module does not receive another command before the expiry of the delay time-period and the process proceeds to step 618.

At step 618, the process ends. In the exemplary embodiment, the relay device exits the “communication mode”. Further, in the exemplary embodiment, at step 618, the processing module triggers the indication LED to blink (differently from that at step 608 and step 612) to indicate to the user that the processing module has exited the “communication mode”. For example, the indication LED blinks in a slower sequence than at both steps 608 and 612.

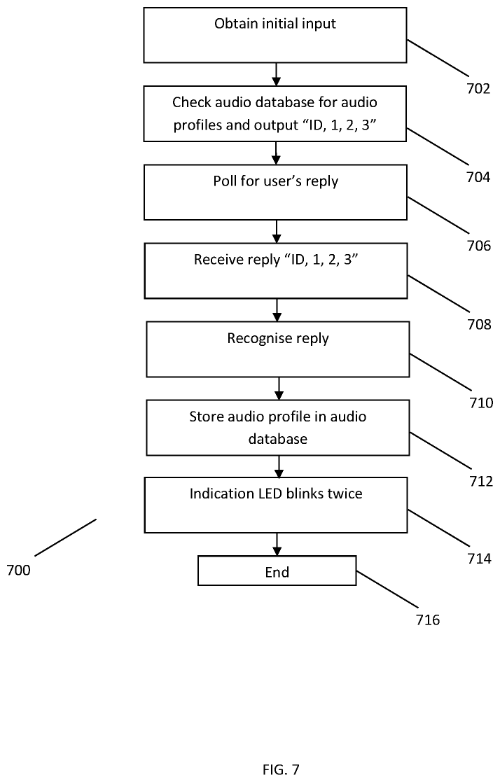

FIG. 7 is a schematic flowchart 700 for illustrating a process for initialising voice recognition for a relay device in an exemplary embodiment. The relay device is substantially similar to the relay device 200 described with reference to FIGS. 2A and 2B. In the exemplary embodiment, the process is carried out, for example, before the user uses the relay device or, for example, when the relay device is installed at a manufacturing facility. The process is for providing an audio database of the relay device with an audio profile.

At step 702, the relay device obtains an initial input. An input may be a power supply to trigger power up of the relay device.

At step 704, a processing module of the relay device checks that the relay device has no audio profiles stored in the audio database. In the exemplary embodiment, if the processing module determines that there are no audio profiles stored in the audio database, an indication LED of the relay device for e.g. turns on to invite the user to provide a command. Further, in the exemplary embodiment, if the processing module determines that there are no audio profiles stored in the audio database, the processing module triggers a speaker of the relay device to output a pre-determined message (in the form of an audio signal) to invite the user to provide a command. For example, the pre-determined message is “ID, 1, 2, 3”.

At step 706, the processing module polls for a reply by the user via a microphone of the relay device.

At step 708, the user provides a reply “ID, 1, 2, 3” to the relay device via the microphone.

At step 710, the processing module recognises the reply from the user i.e. the reply corresponds to the invitation message of step 704.

At step 712, the processing module stores the audio profile of the user in the audio database.

At step 714, the processing module triggers the indication LED to output a visual signal to the user that the user's audio profile has been stored in the audio database successfully. For example, the indication LED blinks twice.

At step 716, the process ends.

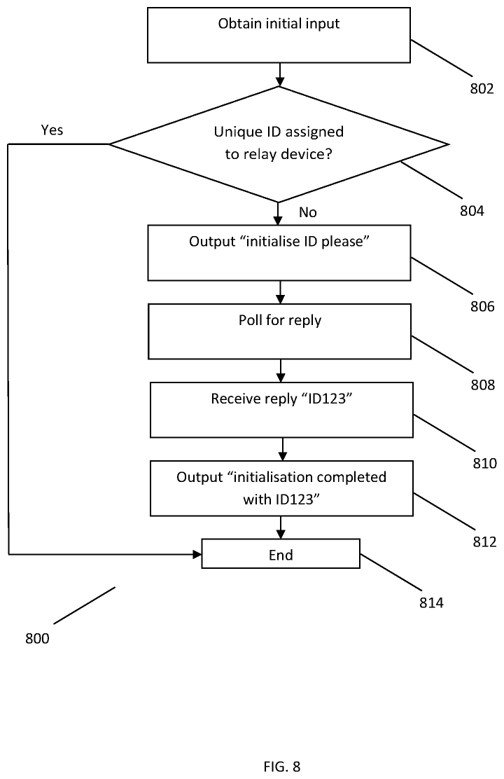

FIG. 8 is a schematic flowchart 800 for illustrating a process for assigning a unique ID to a relay device in an exemplary embodiment. The relay device is substantially similar to the relay device 200 described with reference to FIGS. 2A and 2B.

At step 802, the relay device obtains an initial input. An input may be a power supply to trigger power up of the relay device.

At step 804, a processing module of the relay device checks whether there is a unique ID assigned to the relay device. If the processing module determines that there is a unique ID assigned to the relay device, the process ends. If the processing module determines that there is no unique ID assigned to the relay device, the process proceeds to step 806.

At step 806, the processing module triggers a speaker of the relay device to output a first pre-determined message (in the form of an audio signal) to invite the user to provide a unique ID to be assigned to the relay device. For example, the first pre-determined message is “initialise ID please”.

At step 808, the processing module polls for a reply by the user via a microphone of the relay device.

At step 810, the user provides a reply “ID123” to the relay device via the microphone.

At step 812, the processing module triggers the speaker to output a second pre-determined message (also in the form of an audio signal) to indicate to the user that the relay device has successfully been assigned with a unique ID. For example, the second pre-determined message is “initialisation completed with ID123”. In the exemplary embodiment, the processing module may further trigger an indication LED to output a visual signal to indicate to the user that the relay device has successfully been assigned with a unique ID. For example, the indication LED may blink once. At this step, the audio reply “ID123” by the user is recognised by the processing module and stored as the unique ID of the relay device.

At step 814, the process ends.

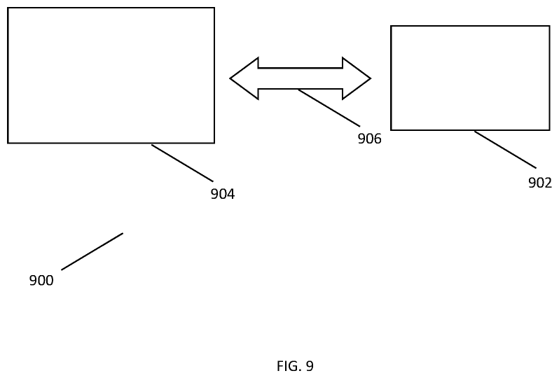

FIG. 9 is a schematic diagram 900 illustrating a system for configuring a relay device in an exemplary embodiment.

The system 900 for configuring the relay device 902 comprises a relay device 902 coupled to a computer system 904, the coupling via a communication interface 906.

In the exemplary embodiment, the relay device 902 is substantially similar to the relay device 100 described with reference to FIG. 1.

In the exemplary embodiment, the computer system 904 may be implemented as a personal computer, a laptop or a tablet. In the exemplary embodiment, the computer system 904 comprises a processing module database. The processing module database stores a firmware which may be programmed by a user.

In the exemplary embodiment, the communication interface 906 is implemented as a universal asynchronous receiver-transmitter (UART) interface. However, in other exemplary embodiments, the communication interface 906 may be implemented as any wired or wireless communication interface.

In the exemplary embodiment, when in use, the relay device 902 may be coupled to the computer system 904 via the communication interface 906. When the relay device 902 and the computer system 904 are coupled in such a manner, the user may for example, write or edit one or more instructions associated with one or more settings of the relay device 902 and/or one or more possible fault conditions of the relay device 902. For example, the user may also erase or amend the unique ID of the relay. For example, the user may edit an audio profile database of the relay device. The programmed firmware may then be loaded via the communication interface 906 into the relay device 902.

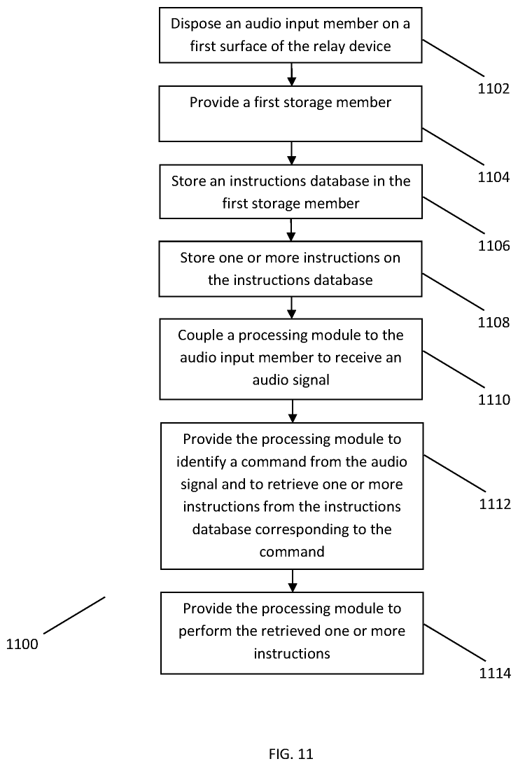

FIG. 11 is a schematic flowchart 1100 for illustrating a method of forming a relay device in an exemplary embodiment. The relay device is substantially similar to the relay device 100 described with reference to FIG. 1. At step 1102, an audio input member is disposed on a first surface of the relay device. At step 1104, a first storage member is provided. At step 1106, an instructions database is stored in the first storage member. At step 1108, one or more instructions are stored on the instructions database, each instruction corresponding to a command. At step 1110, a processing module is coupled to the audio input member to receive an audio signal from the audio input member. At step 1112, the processing module is provided to identify a command from the audio signal and to retrieve one or more instructions from the instructions database corresponding to the command. At step 1114, the processing module is provided to perform the retrieved one or more instructions.

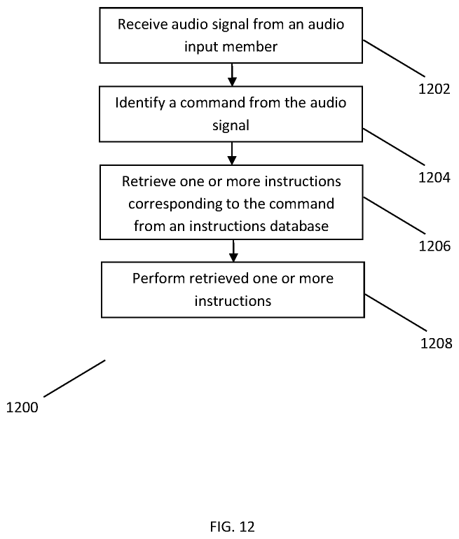

FIG. 12 is a schematic flowchart 1200 illustrating a method of controlling a relay device in an exemplary embodiment. The relay device is substantially similar to the relay device 100 described with reference to FIG. 1. At step 1202, an audio signal is received from an audio input member disposed on a first surface of the relay device. At step 1204, a command is identified from the audio signal. At step 1206, one or more instructions corresponding to the command are retrieved from an instructions database. The instructions database is stored in a first storage member of the relay device, the instructions database having stored thereon one or more instructions, each instruction corresponding to a command. At step 1208, the retrieved one or more instructions are performed.

In an exemplary embodiment, a relay device may be provided. It may be provided that an audio input member (e.g. a microphone) of the relay device is listening for an audio command. In a “communication mode”, it may be provided that a processing module of the relay device identifies a command from an audio signal and retrieves one or more instructions corresponding to the command. The processing module may be provided to perform the one or more received instructions. The one or more instructions may be stored in an instructions database that is in turn stored on a storage member of the relay device. In the exemplary embodiment, to enter the “communication mode”, it may be provided that a matching of a unique ID of the relay device is performed with a unique ID received with an audio command. Alternatively, or in addition, it may be provided that the relay device comprises an actuator, e.g. a trigger button, for a user to actuate to cause the processing module to enter into the “communication mode”.

In the exemplary embodiment, the relay device may be provided to exit the “communication mode” by a user's command (e.g. via an audio command or e.g. via the alternative/additional actuator) or by a time-out process.

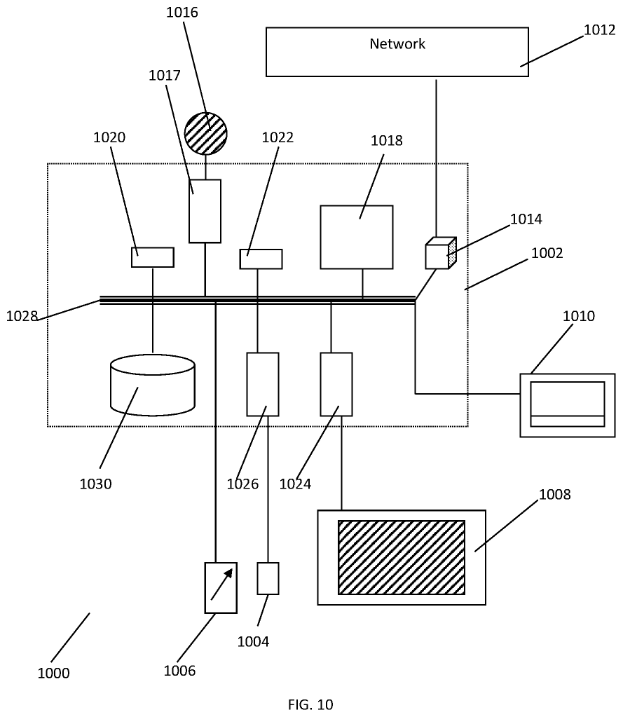

FIG. 10 is a schematic drawing of a computer system suitable for storing instructions in a relay device in an exemplary embodiment. The relay device is substantially similar to the relay device 100 described with reference to FIG. 1. The computer system is substantially similar to the computer system 904 described with reference to FIG. 9.

Different exemplary embodiments can be implemented in the context of data structure, program modules, program and computer instructions executed in a computer implemented environment. A general purpose computing environment is briefly disclosed herein. One or more exemplary embodiments may be embodied in one or more computer systems, such as is schematically illustrated in FIG. 10. For example, a server computer coupled to a relay device of exemplary embodiments may use a portion or all of the components described below.

One or more exemplary embodiments may be implemented as software, such as a computer program being executed within a computer system 1000, and instructing the computer system 1000 to conduct an operation of an exemplary embodiment.

The computer system 1000 comprises a computer unit 1002, input modules such as a keyboard 1004 and a pointing device 1006 and a plurality of output devices such as a display 1008, and printer 1010. A user can interact with the computer unit 1002 using the above devices. The pointing device can be implemented with a mouse, track ball, pen device or any similar device. One or more other input devices (not shown) such as a touch sensitive screen or the like can also be connected to the computer unit 1002. The display 1008 may include a cathode ray tube (CRT), liquid crystal display (LCD), field emission display (FED), plasma display or any other device that produces an image that is viewable by the user.

The computer unit 1002 can be connected to a computer network 1012 via a suitable transceiver device 1014, to enable access to e.g. the Internet or other network systems such as Local Area Network (LAN) or Wide Area Network (WAN) or a personal network. The network 1012 can comprise a server, a router, a network personal computer, a peer device or other common network node, a wireless telephone or wireless personal digital assistant. Networking environments may be found in offices, enterprise-wide computer networks and home computer systems etc. The transceiver device 1014 can be a modem/router unit located within or external to the computer unit 1002, and may be any type of modem/router such as a cable modem or a satellite modem.

It will be appreciated that network connections shown are exemplary and other ways of establishing a communications link between computers can be used. The existence of any of various protocols, such as TCP/IP, Frame Relay, Ethernet, FTP, HTTP and the like, is presumed, and the computer unit 1002 can be operated in a client-server configuration to permit a user to retrieve web pages from a web-based server. Furthermore, any of various web browsers can be used to display and manipulate data on web pages.

The computer unit 1002 in the example comprises a processor 1018, a Random Access Memory (RAM) 1020 and a Read Only Memory (ROM) 1022. The ROM 1022 can be a system memory storing basic input/output system (BIOS) information. The RAM 1020 can store one or more program modules such as operating systems, application programs and program data.

For example, for a computer system that is to be coupled to a relay device (such as relay device 100 described with reference to FIG. 1), the RAM 1020 may store a first firmware for managing the relay device. For example, through the first firmware, the processor 1018 may function to program and store a second firmware in the first storage member of the relay device. The processor 1018 may further function to write or edit one or more instructions (e.g. settings, readings, fault conditions) that may be stored in the instructions database of the relay device through the second firmware. In the exemplary embodiment, the above actions are performed before the relay device is in operation. Further, in this example, communication between the computer system and the relay device may be through a UART interface.

The computer unit 1002 further comprises a number of Input/Output (I/O) interface units, for example I/O interface unit 1024 to the display 1008, and I/O interface unit 1026 to the keyboard 1004. In one exemplary embodiment, an I/O interface unit may be a UART interface. The components of the computer unit 1002 typically communicate and interface/couple connectedly via an interconnected system bus 1028 and in a manner known to the person skilled in the relevant art. The bus 1028 can be any of several types of bus structures including a memory bus or memory controller, a peripheral bus, and a local bus using any of a variety of bus architectures.

For example, for a computer system that is to be coupled to the relay device e.g. using a UART interface, an I/O interface unit may be used to write or edit one or more instructions that may be stored in the instructions database of the relay device.

It will be appreciated that other devices can also be connected to the system bus 1028. For example, a universal serial bus (USB) interface can be used for coupling a video or digital camera to the system bus 1028. An IEEE 1394 interface may be used to couple additional devices to the system bus 1028. Other manufacturer interfaces are also possible such as FireWire developed by Apple Computer and i.Link developed by Sony. Coupling of devices to the system bus 1028 can also be via a parallel port, a PCI board or any other interface used to couple an input device to a computer. It will also be appreciated that, while the components are not shown in the figure, sound/audio can be recorded and reproduced with a microphone and a speaker. A sound card may be used to couple a microphone and a speaker to the system bus 1028. It will be appreciated that several peripheral devices can be coupled to the system bus 1028 via alternative interfaces simultaneously.

An application program can be supplied to the user of the computer system 1000 being encoded/stored on a data storage medium such as a CD-ROM or flash memory carrier. The application program can be read using a corresponding data storage medium drive of a data storage device 1030. The data storage medium is not limited to being portable and can include instances of being embedded in the computer unit 1002. The data storage device 1030 can comprise a hard disk interface unit and/or a removable memory interface unit (both not shown in detail) respectively coupling a hard disk drive and/or a removable memory drive to the system bus 1028. This can enable reading/writing of data. Examples of removable memory drives include magnetic disk drives and optical disk drives. The drives and their associated computer-readable media, such as a floppy disk provide non-volatile storage of computer readable instructions, data structures, program modules and other data for the computer unit 1002. It will be appreciated that the computer unit 1002 may include several of such drives. Furthermore, the computer unit 1002 may include drives for interfacing with other types of computer readable media.

The application program is read and controlled in its execution by the processor 1018. Intermediate storage of program data may be accomplished using RAM 1020. The method(s) of the exemplary embodiments can be implemented as computer readable instructions, computer executable components, or software modules. One or more software modules may alternatively be used. These can include an executable program, a data link library, a configuration file, a database, a graphical image, a binary data file, a text data file, an object file, a source code file, or the like. When one or more computer processors execute one or more of the software modules, the software modules interact to cause one or more computer systems to perform according to the teachings herein.

The operation of the computer unit 1002 can be controlled by a variety of different program modules. Examples of program modules are routines, programs, objects, components, data structures, libraries, etc. that perform particular tasks or implement particular abstract data types. The exemplary embodiments may also be practiced with other computer system configurations, including handheld devices, multiprocessor systems, microprocessor-based or programmable consumer electronics, network PCs, minicomputers, mainframe computers, personal digital assistants, mobile telephones and the like. Furthermore, the exemplary embodiments may also be practiced in distributed computing environments where tasks are performed by remote processing devices that are linked through a wireless or wired communications network. In a distributed computing environment, program modules may be located in both local and remote memory storage devices.

The above described exemplary embodiments may provide a relay device that may be controlled (e.g. to change/adjust one or more settings of a relay deice and/or to request for information on the relay device) using voice recognition and may provide a method for controlling a relay device using voice recognition. Further, the above described exemplary embodiments may provide a relay device that may output one or more audio signals (via an audio output member (e.g. a speaker)).

The above described exemplary embodiments may eliminate possible issues with using dials or dial buttons to control the relay device (e.g. having to use a tool to manipulate dials, not being able to accurately adjust the dials and not being able to adjust a certain setting of a particular relay device) since a user may use audio commands to control a relay device.

The above described exemplary embodiments may also eliminate possible issues with using or providing LED indicators and/or LCDs to alert/inform users of faults and/or communicating other information such as settings or readings to users. For example, a user may not need to count a number of times a LED indicator blinks and consequently interpret the type of fault detected incorrectly since audio read-back may be provided by the exemplary embodiments. In addition, by using an audio read-back, displays may be removed and constraints on the size of the final relay device may also be removed.

The above described exemplary embodiments may further eliminate the need for a user to be in possession of an instruction/specification list or sheet when controlling a relay device since audio read-back may be provided by the exemplary embodiments.

In the described exemplary embodiments, a user may be able to control the relay device with more ease when audio commands are used. Further, in the described exemplary embodiments, in a scenario where a relay device detects a fault, a user may be informed of the fault detected simply through one or more audio signals outputted by the relay device (without having in possession an instruction/specification list or sheet for the relay device) e.g. via having audio signals in the form of the human language or with pre-prepared phrases. Thus, a user may also eliminate errors e.g. in listening for or counting “beep sounds” that may lead to wrong interpretation of faults/states.

The terms “coupled” or “connected” as used in this description are intended to cover both directly connected or connected through one or more intermediate means, unless otherwise stated.

In addition, the communications described in the present disclosure may be wireless communications, wired communications or both.

The description herein may be, in certain portions, explicitly or implicitly described as algorithms and/or functional operations that operate on data within a computer memory or an electronic circuit. These algorithmic descriptions and/or functional operations are usually used by those skilled in the information/data processing arts for efficient description. An algorithm is generally relating to a self-consistent sequence of steps leading to a desired result. The algorithmic steps can include physical manipulations of physical quantities, such as electrical, magnetic or optical signals capable of being stored, transmitted, transferred, combined, compared, and otherwise manipulated.

Further, unless specifically stated otherwise, and would ordinarily be apparent from the following, a person skilled in the art will appreciate that throughout the present specification, discussions utilizing terms such as “scanning”, “calculating”, “determining”, “replacing”, “generating”, “initialising”, “outputting”, and the like, refer to action and processes of an instructing processor/computer system, or similar electronic circuit/device/component, that manipulates/processes and transforms data represented as physical quantities within the described system into other data similarly represented as physical quantities within the system or other information storage, transmission or display devices etc.

The description also discloses relevant device/apparatus for performing the steps of the described methods. Such apparatus may be specifically constructed for the purposes of the methods, or may comprise a general purpose computer/processor or other device selectively activated or reconfigured by a computer program stored in a storage member. The algorithms and displays described herein are not inherently related to any particular computer or other apparatus. It is understood that general purpose devices/machines may be used in accordance with the teachings herein. Alternatively, the construction of a specialised device/apparatus to perform the method steps may be desired.

In addition, it is submitted that the description also implicitly covers a computer program, in that it would be clear that the steps of the methods described herein may be put into effect by computer code. It will be appreciated that a large variety of programming languages and coding can be used to implement the teachings of the description herein. Moreover, the computer program if applicable is not limited to any particular control flow and can use different control flows without departing from the scope of the present disclosure.

Furthermore, one or more of the steps of the computer program if applicable may be performed in parallel and/or sequentially. Such a computer program if applicable may be stored on any computer readable medium. The computer readable medium may include storage devices such as magnetic or optical disks, memory chips, or other storage devices suitable for interfacing with a suitable reader/general purpose computer. In such instances, the computer readable storage medium is non-transitory. Such storage medium also covers all computer-readable media e.g. medium that stores data only for short periods of time and/or only in the presence of power, such as register memory, processor cache and Random Access Memory (RAM) and the like. The computer readable medium may even include a wired medium such as exemplified in the Internet system, or wireless medium such as exemplified in Bluetooth technology. The computer program when loaded and executed on a suitable reader effectively results in an apparatus that can implement the steps of the described methods.

The exemplary embodiments may also be implemented as hardware modules. A module is a functional hardware unit designed for use with other components or modules. For example, a module may be implemented using digital or discrete electronic components, or it can form a portion of an entire electronic circuit such as an Application Specific Integrated Circuit (ASIC). A person skilled in the art will understand that the exemplary embodiments can also be implemented as a combination of hardware and software modules.

Additionally, when describing some embodiments, the disclosure may have disclosed a method and/or process as a particular sequence of steps. However, unless otherwise required, it will be appreciated the method or process should not be limited to the particular sequence of steps disclosed. Other sequences of steps may be possible. The particular order of the steps disclosed herein should not be construed as undue limitations. Unless otherwise required, a method and/or process disclosed herein should not be limited to the steps being carried out in the order written. The sequence of steps may be varied and still remain within the scope of the disclosure.

Further, in the description herein, the word “substantially” whenever used is understood to include, but not restricted to, “entirely” or “completely” and the like. In addition, terms such as “comprising”, “comprise”, and the like whenever used, are intended to be non-restricting descriptive language in that they broadly include elements/components recited after such terms, in addition to other components not explicitly recited. Further, terms such as “about”, “approximately” and the like whenever used, typically means a reasonable variation, for example a variation of +/−5% of the disclosed value, or a variance of 4% of the disclosed value, or a variance of 3% of the disclosed value, a variance of 2% of the disclosed value or a variance of 1% of the disclosed value.

In the above described exemplary embodiments, commands have been described to be associated with one or more settings of a relay device, one or more readings of a relay device, or one or more fault conditions related to a relay device. However, it will be appreciated that the exemplary embodiments are not limited as such. That is, the commands may be associated with any suitable functions for a relay device.

In various exemplary embodiments, it has been described that the user is provided with one or more visual signals from a visual output member (e.g. blinking of a visual indicator) of a relay device. However, it will be appreciated that the exemplary embodiments are not limited as such. The user may alternatively, or additionally, be provided with one or more audio signals or feedback from the audio output member of a relay device. The visual output member, e.g. a LED, may be optional.

Further, a relay device of exemplary embodiments may be modified to provide an actuator, such as a trigger button, to implement the process of using the first audio command for the relay device to enter the “communication mode”. That is, it is possible to provide an actuator by which a user may actuate to instruct the processing module of the relay device to enter the “communication mode”.

In various exemplary embodiments, it has been described that an audio profile of a user is stored in the audio database of the relay device and that the processing module of the relay device checks whether the audio profile of the user providing the first audio command matches an audio profile stored in the audio database. However, it will be appreciated that the exemplary embodiments are not limited as such. It may be provided that the processing module may not need to check whether the audio profiles match. In such a scenario, the relay device may receive audio commands from different users as long as the commands are recognisable and correspond to one or more instructions stored in the instructions database of the relay device. That is, it is possible to modify the relay device such that using audio profiles, and therefore voice recognition, is optional.

In the described exemplary embodiments, the relay device may be configured to output an audio signal to a user. The pre-prepared phrases (e.g. “under voltage 120”) may be in the form of audio signals formulated by blocks of one or more words (e.g. “under voltage”) and/or one or more values (e.g. “120 volts”). These blocks of one or more words and/or one or more values are stored in the first storage member as e.g. text or recorded audio files. If the blocks of one or more words and/or one or more values are stored as text, the processing module may be configured to perform text-to-audio processing.

In various described exemplary embodiments, it may be provided that a delay time-period is provided as a window when a relay device begins to exit a “communication mode”. That is, an audio command received during that window may cause the relay device to abandon exiting the “communication mode”. It will be appreciated that the exemplary embodiments are not limited as such. That is, it may alternatively be provided that the relay device exits the “communication mode” without providing a delay time-period as a window.

In the described exemplary embodiments, it may be provided that if an audio command is not recognisable by a relay device e.g. an incorrect audio command with no corresponding instruction, it may be provided that the relay device outputs an invitation for a correct audio command and/or an indication (audio and/or visual) to the user that an invalid or unrecognisable command has been received. For example, a relay device may output an audio signal “Invalid command received. Please try again.”.

It will be appreciated by a person skilled in the art that other variations and/or modifications may be made to the specific embodiments without departing from the scope of the present disclosure as broadly described. The present embodiments are, therefore, to be considered in all respects to be illustrative and not restrictive.

What is claimed is:

1. A relay device, the relay device comprising,
an audio input member disposed on a first surface of the relay device;
a first storage member;
an instructions database stored in the first storage member, the instructions database configured to store one or more instructions, each instruction corresponding to a command; and
a processing module coupled to the audio input member and arranged to receive an audio signal from the audio input member;
wherein the processing module is further arranged to identify a command from the audio signal and to retrieve one or more instructions from the instructions database corresponding to the command, and the processing module is further arranged to perform the retrieved one or more instructions.

2. The relay device as claimed in claim 1, further wherein the processing module is arranged to enter a communication mode upon receiving a unique ID of the relay device as the command.

3. The relay device as claimed in claim 1, further comprising at least one output member disposed on the first surface or a second surface of the relay device and coupled to the processing module.

4. The relay device as claimed in claim 3, wherein the at least one output member is an audio output member.

5. (canceled)

6. The relay device as claimed in claim 3, wherein the at least one output member is a visual output member.

7. (canceled)

8. The relay device as claimed in claim 1, further comprising an audio database configured to store audio profiles of one or more users, the audio database being stored on the first storage member.

9. The relay device as claimed in claim 1, further comprising an actuator coupled to the processing module of the relay device, the actuator configured to cause the processing module to begin identification of the command from the audio signal.

10. A method of forming a relay device, the method comprising,
disposing an audio input member on a first surface of the relay device;
providing a first storage member;
storing an instructions database in the first storage member;
storing one or more instructions on the instructions database, each instruction corresponding to a command;
coupling a processing module to the audio input member to receive an audio signal from the audio input member;
providing the processing module to identify a command from the audio signal and to retrieve one or more instructions from the instructions database corresponding to the command; and
providing the processing module to perform the retrieved one or more instructions.

11. The method as claimed in claim 10, further comprising providing the processing module to enter a communication mode upon receiving a unique ID of the relay device as the command.

12. The method as claimed in claim 10, further comprising disposing at least one output member on the first surface or a second surface of the relay device and coupling the at least one output member to the processing module.

13. The method as claimed in claim 10, further comprising storing audio profiles of one or more users on an audio database, the audio database being stored on the first storage member.

14. The method as claimed in claim 10, further comprising coupling an actuator to the processing module of the relay device to cause the processing module to begin identification of the command from the audio signal.

15. A method of controlling a relay device, the method comprising,
receiving an audio signal from an audio input member disposed on a first surface of the relay device;
identifying a command from the audio signal;
retrieving one or more instructions from an instructions database corresponding to the command, the instructions database being stored in a first storage member of the relay device, the instructions database having stored thereon one or more instructions, each instruction corresponding to a command; and
performing the retrieved one or more instructions.

16. The method as claimed in claim 15, further comprising entering a communication mode upon receiving a unique ID of the relay device as the command.

17. The method as claimed in claim 15, further comprising providing at least one output from the relay device via an output member.

18. The method as claimed in claim 17, wherein the at least one output is an audio output.

19. The method as claimed in claim 17, wherein the at least one output is a visual output.

20. The method as claimed in claim 15, further comprising using an audio database having stored thereon audio profiles of one or more users, the audio database being stored on the first storage member.

21. The method as claimed in claim 15, further comprising actuating an actuator of the relay device to begin the step of identifying a command from the audio signal.

22. A non-transitory computer readable storage medium having stored thereon instructions for instructing a processing module of a relay device to execute a method of controlling a relay device, the method comprising,
receiving an audio signal from an audio input member disposed on a first surface of the relay device;
identifying a command from the audio signal;
retrieving one or more instructions from an instructions database corresponding to the command, the instructions database being stored in a first storage member of the relay device, the instructions database having stored thereon one or more instructions, each instruction corresponding to a command; and
performing the retrieved one or more instructions.
